(19) United States
(12) Patent Application Publication
(10) Pub. No.: US 2026/0216937 A1
(43) Pub. Date: Jul. 30, 2026

(54) MULTI-LAYER FILM, AND MULTI-LAYER STRUCTURE USING SAME

(71) Applicant: Kuraray Co., Ltd., Okayama (JP)

(72) Inventors: Masahiro KITAMURA, Melsele (BE); Takuya MURAMOTO, Kurashiki-shi, Okayama (JP); Kentaro YOSHIDA, Kurashiki-shi, Okayama (JP)

(73) Assignee: Kuraray Co., Ltd., Okayama (JP)

(21) Appl. No.: 18/722,546

(22) PCT Filed: Dec. 22, 2022
(86) PCT No.: PCT/JP2022/047364

§ 371 Date: Jun. 20, 2024

(30) Foreign Application Priority Data
Dec. 23, 2021 (JP) 2021-209380

(51) Int. Cl. B29C 48/21; B29B 17/04; B29C 48/00; B29C 48/08; B29C 55/04; B29C 55/14; B29C 71/00; B29K 23/00; B29L 7/00; B29L 31/00

(52) U.S. Cl. CPC B29C 48/21; B29B 17/04; B29C 48/0018; B29C 48/022; B29C 48/08; B29C 55/04; B29C 55/14; B29C 71/009; B29B 2017/0468; B29K 2023/06; B29K 2023/086; B29L 2007/008; B29L 2031/712

(57) ABSTRACT

There is provided a multi-layer film comprising at least a layer (X), a layer (Y), and a layer (Z) adjacently layered in this order, with the layer (X) being an outermost layer, wherein the layer (X) is made of a resin composition (A) containing a modified ethylene-vinyl alcohol copolymer (a) obtained by modification with an epoxy compound and having a melting point of 110° C. or more and less than 150° C. as a main component, the layer (Y) comprises an adhesive resin (B) having a melting point of less than 150° C. as a main component, the layer (Z) comprises a polyethylene resin (C) having a melting point of less than 150° C. as a main component, and the resin composition (A) contains 20 to 1500 ppm of an alkali metal ion (b). Even though including an outermost layer made of modified EVOH obtained by modification with an epoxy compound, such a multi-layer film is excellent in appearance, interlayer adhesion, gas barrier properties, and blocking resistance.

### TECHNICAL FIELD

The present invention relates to a multi-layer film including an outermost layer made of an ethylene-vinyl alcohol copolymer modified with an epoxy compound and having a melting point of 110° C. or more and less than 150° C. and a multi-layer structure therewith, and a method for recycling the multi-layer structure and a recycled composition containing a recycled material from the multi-layer structure.

### BACKGROUND ART

Packaging materials for long-term storage of foods are often required to have gas barrier properties such as an oxygen barrier property. Oxidation degradation of foods by oxygen ingress and propagation of microorganisms can be suppressed by using a packaging material having higher gas barrier properties. Metal foil such as aluminum foil and inorganic vapor-deposited layers including those made of silicon oxide or aluminum oxide have been extensively used as a layer that provides improved gas barrier properties. Meanwhile, resin layers having gas barrier properties such as those made of a vinyl alcohol polymer or a polyvinylidene chloride have been extensively used. Vinyl alcohol polymers are characterized in that they are crystallized and densified by intramolecular hydrogen bonding between hydroxy groups to exhibit gas barrier properties. In particular, ethylene-vinyl alcohol copolymers (hereinafter, sometimes abbreviated as “EVOH”) exhibit excellent thermal stability, and hence are suitable for melt-molding, and the development of co-extrusion techniques is promoting extensive use of multi-layer films having an EVOH layer as an intermediate layer for packaging materials having gas barrier properties (Patent Literature 1).

Recent environmental problems and waste problems have been boosting the global demand for what is called post-consumer recycling (hereinafter, sometimes simply abbreviated as “recycling”), in which packaging materials consumed in the market are recovered and recycled. Common recycling processes include cutting a recovered packaging material with optional sorting and washing, and then melt-mixing the resultant by using an extruder.

### CITATION LIST

### Patent Literature

Patent Literature 1: WO 2020/071513

### SUMMARY OF INVENTION

### Technical Problem

Meanwhile, demand for the diversification of layer configuration and synergistic effect for improved barrier properties that is given by lamination with an inorganic vapor-deposited layer has been promoting use of an EVOH layer for the outermost layer of a multi-layer film. In multi-layer melt molding in this case, an EVOH layer comes into direct contact with a die wall and the EVOH layer discharged from the die is rapidly cooled, disadvantageously resulting in appearance failure due to unevenness in thickness and delamination due to insufficient interlayer adhesion in some cases. Such problems as appearance failure and delamination tend to more frequently arise in monoaxially or biaxially stretching a multi-layer film in the hope of enhanced mechanical properties or the like, and thus an improved multi-layer film has been demanded. The present inventors have diligently examined to find that a multi-layer film superior in appearance and interlayer adhesion can be provided by a configuration in which EVOH present in the outermost layer has a melting point of less than 150° C. and has a certain metal ion. On the other hand, it has been found that blocking is disadvantageously caused in stretching if the melting point of EVOH present in the outermost layer is excessively low. In addition, modification with an epoxy compound has been found to be an optimum solution for minimizing the reduction in oxygen barrier properties and reducing the production cost in producing EVOH having a low melting point (less than 150° C.).

In view of such circumstances, a first object of the present invention is to provide a multi-layer film including an outermost layer made of modified EVOH obtained by modification with an epoxy compound and being excellent in appearance, interlayer adhesion, gas barrier properties, and blocking resistance. A second object of the present invention is to provide, by using the multi-layer film, a multi-layer structure that achieves both gas barrier properties and recyclability, and a packaging material including the multi-layer structure, a recycled composition containing a recycled material from the multi-layer structure, and a method for recycling the multi-layer structure.

### Solution to Problem

The objects can be achieved by providing the followings.
[1] A multi-layer film comprising at least a layer (X), a layer (Y), and a layer (Z) adjacently layered in this order, with the layer (X) being an outermost layer, wherein the layer (X) is made of a resin composition (A) comprising a modified ethylene-vinyl alcohol copolymer (a) obtained by modification with an epoxy compound and having a melting point of 110° C. or more and less than 150° C. as a main component (hereinafter, sometimes abbreviated as “modified EVOH (a)”), the layer (Y) comprises an adhesive resin (B) having a melting point of less than 150° C. as a main component, the layer (Z) comprises a polyethylene resin (C) having a melting point of less than 150° C. as a main component, and the resin composition (A) contains 20 to 1500 ppm of an alkali metal ion (b).
[2] The multi-layer film according to [1], wherein the modified EVOH (a) has an ethylene unit content of 20 to 60 mol %.
[3] The multi-layer film according to [1] or [2], wherein the modified EVOH (a) has a modifying group represented by the following general formula (I):

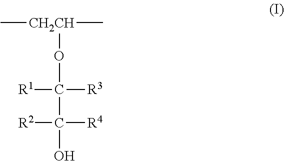

wherein R¹, R², R³, and R⁴ each independently represent a hydrogen atom, an aliphatic hydrocarbon group having 1 to 10 carbon atoms, an alicyclic hydrocarbon group having 3 to 10 carbon atoms, or an aromatic hydrocarbon group having 6 to 10 carbon atoms, R³ and R⁴ are optionally bonded to each other, and some or all of the hydrogen atoms of the aliphatic hydrocarbon group, the alicyclic hydrocarbon group, and the aromatic hydrocarbon group are each optionally replaced with a hydroxy group, a carboxyl group, or a halogen atom.
[4] The multi-layer film according to [3], wherein in the modified EVOH (a), a content of the modifying group represented by the general formula (I) is 1 mol % or more and less than 20 mol %.
[5] The multi-layer film according to any one of [1] to [4], wherein the adhesive resin (B) contains a carboxylic-acid-modified polyethylene resin as a main component.
[6] The multi-layer film according to any one of [1] to [5], wherein the layer (X) has a thickness of 0.2 μm or more and less than 20 μm, and a ratio of the thickness of the layer (X) to the total thickness of all layers of the multi-layer film is less than 25%.
[7] The multi-layer film according to any one of [1] to [6], wherein the multi-layer film is stretched at least monoaxially by 3 times or more and less than 12 times.
[8] The multi-layer film according to any one of [1] to [7], wherein the multi-layer film is stretched biaxially by 3 times or more and less than 12 times in each direction.
[9] A vapor-deposited multi-layer film, comprising the multi-layer film according to any one of [1] to [8] comprising an inorganic vapor-deposited layer (I) on an exposed surface side of the layer (X).
[10] The multi-layer film or the vapor-deposited multi-layer film according to any one of [1] to [9], wherein the multi-layer film or the vapor-deposited multi-layer film performs an oxygen transmission rate (under conditions of 20° C., 65% RH) of less than 60 cc/(m²·day·atm) as measured in accordance with a method described in JIS K 7126-2 (equal-pressure method; 2006).
[11] A multi-layer structure, being a laminate of the multi-layer film or the vapor-deposited multi-layer film according to any one of [1] to [10], and at least one resin layer (R) comprising a thermoplastic resin (D) as a main component.
[12] The multi-layer structure according to [11], wherein the thermoplastic resin (D) contains a polyethylene resin as a main component.
[13] The multi-layer structure according to [11] or [12], wherein a ratio of the total thickness of a layer or layers containing a polyethylene resin as a main component to the total thickness of the multi-layer structure is 0.75 or more.
[14] The multi-layer structure according to any one of [11] to [13], comprising neither a layer containing a resin having a melting point of 240° C. or more as a main component nor a metal layer having a thickness of 1 μm or more.
[15] A packaging material comprising the multi-layer structure according to any one of [11] to [14].
[16] A recycled composition comprising a recycled material from the multi-layer structure according to any one of [11] to [14].
[17] A method for recycling a multi-layer structure, the method comprising crushing the multi-layer structure according to any one of [11] to [14] and then melt-molding the resultant.

### Advantageous Effects of Invention

Even though including an outermost layer made of epoxy-modified EVOH, the multi-layer film of the present invention is excellent in appearance, interlayer adhesion, gas barrier properties, and blocking resistance, and hence can be suitably used as a gas barrier film. The multi-layer structure of the present invention, which includes the multi-layer film, is excellent in appearance, and can be suitably used as a packaging material that achieves both gas barrier properties and recyclability. Since the multi-layer structure has good recyclability, there can be provided a recycled composition containing a recycled material from the multi-layer structure and a method for recycling the multi-layer structure. The term “interlayer adhesion” as used herein means the adhesion of the layer (X) to a layer adjacent to the layer (X), specifically, the adhesion primarily to the layer (Y) described later. Interlayer adhesion can be evaluated by T-type peel strength as described in Examples. The term “recyclability” means that in producing a recycled composition by melt-kneading a recycled material from the multi-layer structure or packaging material of the present invention, the coloring and gelation of resin are prevented and thus a recycled composition excellent in appearance and mechanical properties can be efficiently produced. The recyclability can be evaluated by recycling test described in Examples. The term “appearance” means the appearance after a stretching treatment; specifically, the appearance can be evaluated through stretchability evaluation described in Examples.

### DESCRIPTION OF EMBODIMENTS

There will be described embodiments of the present invention. In the following description, specific materials (compounds and the like) that exhibit a particular function may be exemplified, but the present invention is not limited to a mode using such a material. Exemplified materials can be used alone or in combination, unless otherwise specified.

The multi-layer film of the present invention includes at least a layer (X), a layer (Y), and a layer (Z) adjacently layered in this order, with the layer (X) being an outermost layer, wherein the layer (X) is made of a resin composition (A) containing a modified EVOH (a) obtained by modification with an epoxy compound and having a melting point of 110° C. or more and less than 150° C. as a main component, the layer (Y) containing an adhesive resin (B) having a melting point of less than 150° C. as a main component, the layer (Z) contains a polyethylene resin (C) having a melting point of less than 150° C. as a main component, and the resin composition (A) contains 20 to 1500 ppm of an alkali metal ion (b). Here, the phrase “a layer (X), a layer (Y), and a layer (Z) adjacently layered in this order” means that adjacent layers are directly layered; specifically, the layer (X), the layer (Y), and the layer (Z) are layered in this order, in which the layer (X) and the layer (Y) are directly layered while the layer (Y) and the layer (Z) are directly layered. The term “main component” means a component contained at more than 50 mass %.

### <Resin Composition (A)>

The multi-layer film of the present invention includes a layer (X), as an outermost layer, made of a resin composition (A) containing a modified EVOH (a) having a melting point of 110° C. or more and less than 150° C. as a main component, wherein the resin composition (A) contains 20 to 1500 ppm of an alkali metal ion (b).

<Modified EVOH (a)>

Having a melting point of less than 150° C., the modified EVOH (a) allows the multi-layer film including the layer (X), as an outermost layer, containing the modified EVOH (a) as a main component to have improved appearance and interlayer adhesion. This is probably because the melting point of the modified EVOH (a) that is less than 150° C. causes the fluidity of the polymer chain to be enhanced, leading to the achievement of effective stress relaxation and maintenance of the adhesion reaction activity to an adjacent layer, even at a relatively low temperature in melt-molding and secondary processing such as stretching. In addition, the modified EVOH (a) gives improved blocking resistance by virtue of the melting point of 110° C. or more.

Typically, the modified EVOH (a) can be obtained by saponifying an ethylene-vinyl ester polymer and post-modifying the resulting EVOH with an epoxy compound. Production and saponification of an ethylene-vinyl ester polymer can be conducted by a known method.

For enhanced gas barrier properties, the vinyl alcohol unit content of the modified EVOH (a) is preferably 20 mol % or more, more preferably 30 mol % or more, further preferably 40 mol % or more, and particularly preferably 50 mol % or more. For more prominent effects of the present invention, the melting point of the modified EVOH (a) is preferably less than 140° C., more preferably less than 130° C., and further preferably less than 125° C. For more enhanced blocking resistance, on the other hand, the melting point of the modified EVOH (a) may be 115° C. or more or 120° C. or more. The melting point of the modified EVOH (a) is controlled by any one of the followings or two or more thereof in combination.
(1) Changing the ethylene unit content (increasing the ethylene unit content results in lower melting point)
(2) Changing the degree of saponification (decreasing the degree of saponification results in lower melting point)
(3) Introducing a modifying group containing a primary hydroxy group (introducing a modifying group containing a primary hydroxy group results in lower melting point)

As described above, increasing the ethylene unit content of the modified EVOH (a) gives the modified EVOH (a) a lower melting point and improved water resistance, thermal stability, melt-moldability, and secondary processability. If the ethylene unit content of the modified EVOH (a) is too high, insufficient gas barrier properties may result, and the interlayer adhesion to a layer (Y) or inorganic vapor-deposited layer (I) described later may be lower. In this regard, the ethylene unit content of the modified EVOH (a) is preferably 20 mol % or more, more preferably 25 mol % or more, and further preferably 30 mol % or more. The ethylene unit content of the modified EVOH (a) is preferably 60 mol % or less, more preferably 55 mol % or less, and further preferably 50 mol % or less. The ethylene unit content of the modified EVOH (a) can be determined by NMR spectrometry. The modified EVOH (a) may be made of two or more types of EVOH with different ethylene unit contents. The ethylene unit content can be controlled by various methods, for example, through the ethylene pressure and a ratio of a vinyl ester to a solvent in the polymerization process.

As described above, decreasing the degree of saponification of the modified EVOH (a) gives the modified EVOH (a) a lower melting point. If the degree of saponification is too low, insufficient gas barrier properties and thermal stability may result, and the interlayer adhesion to a layer (Y) or inorganic vapor-deposited layer (I) described later may be lower. In this regard, the degree of saponification of the modified EVOH (a) is preferably 60 mol % or more, more preferably 70 mol % or more, further preferably 80 mol % or more, and particularly preferably 90 mol % or more, and may be 99 mol % or more or 99.9 mol % or more. The upper limit of the degree of saponification is 100 mol %, but the upper limit is preferably 99.99 mol % for material balance and energy balance in the production process. Here, the degree of saponification indicates the proportion of the number of vinyl alcohol units to the total number of vinyl alcohol units and vinyl ester units in the modified EVOH (a). The degree of saponification of the modified EVOH (a) can be determined by NMR spectrometry. The modified EVOH (a) may be made of two or more types of EVOH with different degrees of saponification. The degree of saponification can be controlled by various methods, for example, through the amount of an alkali catalyst, water content, reaction temperature, and reaction time in the saponification process. Alternatively, the degree of saponification can be controlled by esterifying a hydroxy group generated through the saponification process with a carboxylic acid such as acetic acid or an anhydride thereof in a post-saponification process.

As described above, introducing a modifying group containing a primary hydroxy group represented by a general formula (I) below by modification with an epoxy compound gives the modified EVOH (a) a lower melting point. The degree of lowering of the melting point per introduction rate depends on the structure of the modifying group containing a primary hydroxy group to be introduced, and introduction of 1 mol % of the modifying group containing a primary hydroxy group represented by a general formula (I) below typically results in lowering of the melting point by about 8 to 11° C.

Control of the melting point by this method enables the lowering of the melting point while the gas barrier properties and thermal stability are fairly maintained, as well as prevention of the lowering of the interlayer adhesion to a layer (Y) and inorganic vapor-deposited layer (I) described later, and thus a multi-layer film particularly excellent in quality and performance can be provided. The reason is probably, for example, that the melting point can be lowered while the amount of hydroxy groups is maintained, and that the primary hydroxy group exhibits high adhesion reaction activity to a layer (Y) and inorganic vapor-deposited layer (I) described later. A content of the modifying group containing a primary hydroxy group of the modified EVOH (a) can be appropriately adjusted in view of the balance between the melting point and various physical properties, and it is often the case that if the content of the modifying group containing a primary hydroxy group is 1 mol % or more and less than 20 mol %, physical properties are well-balanced. The lower limit of the content of the modifying group containing a primary hydroxy group of the modified EVOH (a) is more preferably 2.0 mol %, further preferably 2.5 mol %, and particularly preferably 3.5 mol %. The upper limit of the content of the modifying group containing a primary hydroxy group of the modified EVOH (a) is more preferably 10 mol %, and further preferably 5 mol %.

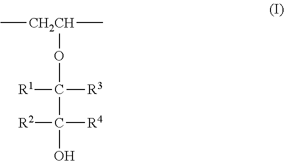

In the formula, R¹, R², R³, and R⁴ each independently represent a hydrogen atom, an aliphatic hydrocarbon group having 1 to 10 carbon atoms, an alicyclic hydrocarbon group having 3 to 10 carbon atoms, or an aromatic hydrocarbon group having 6 to 10 carbon atoms, R³ and R⁴ are optionally bonded to each other, and some or all of the hydrogen atoms of the aliphatic hydrocarbon group, the alicyclic hydrocarbon group, and the aromatic hydrocarbon group are each optionally replaced with a hydroxy group, a carboxyl group, or a halogen atom.

Examples of the aliphatic hydrocarbon group that is used for R¹, R², R³, or R⁴ include an alkyl group and an alkenyl group, examples of the alicyclic hydrocarbon group include a cycloalkyl group and a cycloalkenyl group, and examples of the aromatic hydrocarbon group include a phenyl group.

It is preferable for the modifying group represented by the general formula (I) that R¹ and R² be each a hydrogen atom. In particular, it is more preferable that R¹ and R² be each a hydrogen atom, and one of R³ and R⁴ be the aliphatic hydrocarbon group and the other be a hydrogen atom. This aliphatic hydrocarbon group is preferably any of an alkyl group and an alkenyl group. With special emphasis on gas barrier properties in molded bodies including the multi-layer structure to be obtained, it is more preferable that one of R³ and R⁴ be a methyl group or an ethyl group and the other be a hydrogen atom. It is also preferable that one of R³ and R⁴ be a substituent represented by (CH₂)ₕOH (wherein h is an integer of 1 to 8) and the other be a hydrogen atom. In the substituent represented by (CH₂)ₕOH, h is preferably an integer of 1 to 4, more preferably 1 or 2, and further preferably 1.

Any method may be used for providing EVOH with the modifying group represented by the general formula (I) without limitation; for example, a method is used in which EVOH obtained by saponification reaction is reacted with a monovalent epoxy compound for providing the EVOH with the modifying group.

Examples of the monovalent epoxy compound include epoxyethane (ethylene oxide), epoxypropane, 1,2-epoxybutane, 2,3-epoxybutane, 3-methyl-1,2-epoxybutane, 1,2-epoxypentane, 3-methyl-1,2-epoxypentane, 1,2-epoxyhexane, 2,3-epoxyhexane, 3,4-epoxyhexane, 3-methyl-1,2-epoxyhexane, 3-methyl-1,2-epoxyheptane, 4-methyl-1,2-epoxyheptane, 1,2-epoxyoctane, 2,3-epoxyoctane, 1,2-epoxynonane, 2,3-epoxynonane, 1,2-epoxydecane, 1,2-epoxydodecane, epoxyethylbenzene, 1-phenyl-1,2-epoxypropane, 3-phenyl-1,2-epoxypropane, alkyl glycidyl ethers, alkylene glycol monoglycidyl ethers, alkenyl glycidyl ethers, epoxyalkanols including glycidol, epoxycycloalkanes, and epoxycycloalkenes.

The monovalent epoxy compound preferably has 2 to 8 carbon atoms. In particular, for the handleability and reactivity of the compound, the monovalent epoxy compound more preferably has 2 to 6 carbon atoms, and further preferably has 2 to 4 carbon atoms. For reactivity with EVOH, processability, gas barrier properties, etc., of the resin composition and molded bodies including a film to be obtained, the monovalent epoxy compound is preferably 1,2-epoxybutane, 2,3-epoxybutane, epoxypropane, epoxyethane, or glycidol; especially, the monovalent epoxy compound is more preferably 1,2-epoxybutane, epoxypropane, or glycidol, further preferably 1,2-epoxybutane or epoxypropane, and particularly preferably epoxypropane.

As long as the effects of the present invention are not impaired, the modified EVOH (a) may contain additional monomer units other than ethylene units, vinyl ester units, vinyl alcohol units, and the modifying group containing a primary hydroxy group. The additional monomer unit content is preferably 5 mass % or less, more preferably 3 mass % or less, and further preferably 1 mass % or less, and it is particularly preferable that substantially no additional monomer unit be contained. Examples of the additional monomers include α-olefins such as propylene, n-butene, isobutylene, and 1-hexene; acrylic acid and salts thereof; unsaturated monomers having an acrylic acid ester group; methacrylic acid and salts thereof; unsaturated monomers having a methacrylic acid ester group; acrylamide, N-methylacrylamide, N-ethylacrylamide, N,N-dimethylacrylamide, diacetoneacrylamide, acrylamidopropanesulfonic acid and salts thereof, acrylamidopropyldimethylamine and salts thereof (e.g., quaternary salts); methacrylamide, N-methylmethacrylamide, N-ethylmethacrylamide, methacrylamidopropanesulfonic acid and salts thereof, methacrylamidopropyldimethylamine and salts thereof (e.g., quaternary salts); vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; vinyl cyanides such as acrylonitrile and methacrylonitrile; vinyl halides such as vinyl chloride and vinyl fluoride; vinylidene halides such as vinylidene chloride and vinylidene fluoride; allyl compounds such as allyl acetate, 2,3-diacetoxy-1-allyloxypropane, and allyl chloride; unsaturated dicarboxylic acids such as maleic acid, itaconic acid, and fumaric acid, and salts or esters thereof; vinylsilane compounds such as vinyltrimethoxysilane; and isopropenyl acetate.

(EVOH (a′))

The resin composition (A) may contain less than 50 mass % of an EVOH (a′) having a melting point of 150° C. or more. The contents of the description of the modified EVOH (a) can also be totally applied to the EVOH (a′), except that the melting point is controlled higher. Specifically, an unmodified EVOH is preferably used as the EVOH (a′). The EVOH (a′) is preferably an EVOH having an ethylene unit content of 15 to 60 mol % and a degree of saponification of 90 mol % or more. The lower limit of the ethylene unit content is more preferably 20 mol %, and further preferably 23 mol %. The upper limit of the ethylene unit content is more preferably 55 mol %, and further preferably 50 mol %. The lower limit of the degree of saponification is preferably 95 mol %, and more preferably 99 mol %. The upper limit of the degree of saponification is preferably 100 mol %, and more preferably 99.99 mol %. For cost reduction, the lower limit of the EVOH (a′) content is preferably 5 mass %, more preferably 20 mass %, and further preferably 35 mass %. Meanwhile, for more prominent effects of the present invention, lower EVOH (a′) contents are better for the EVOH (a′) having a melting point of 150° C. or more, and the upper limit is less than 50 mass %; however, it is preferable that substantially no EVOH (a′) be contained. As the EVOH (a′), various brands of “EVAL™ resin” manufactured by Kuraray Co., Ltd. can be preferably used.

<Alkali Metal Ion (b)>

The resin composition (A) contains 20 to 1500 ppm of an alkali metal ion (b). If contained in the resin composition (A) within the range, the alkali metal ion (b) tends to give significantly enhanced interlayer adhesion to a layer (Y) described later. Although the reason has not been clearly understood, significantly enhanced interlayer adhesion as compared with the case that the alkali metal ion (b) is contained in a vinyl alcohol polymer having a higher melting point is given probably because the melting point of the modified EVOH (a), which is a main component of the resin composition (A), being less than 150° C. causes the fluidity of the polymer chain to be enhanced, and therefore the adhesion reaction activity to an adjacent layer is maintained. If the amount of the alkali metal ion (b) is too small, the resin composition (A) tends to become more viscous during melt-molding, and may cause defective appearance such as gel and hard spots, or lowered interlayer adhesion to a layer (Y) described later. If the amount of the alkali metal ion (b) is too large, on the other hand, the resin composition (A) may be excessively decomposed during melt-molding, or suffer from coloring. In this regard, the lower limit of the alkali metal ion (b) content is preferably 25 ppm, more preferably 30 ppm, and further preferably 35 ppm, and may be 40 ppm. The upper limit of the alkali metal ion (b) content is preferably 1000 ppm, more preferably 750 ppm, and further preferably 500 ppm, and may be 300 ppm, 200 ppm, or 100 ppm. The content ratio between the alkali metal ion (b) and a carboxylic acid described later can be controlled to achieve more improved melt-moldability and coloring resistance in the resin composition (A) to be obtained.

Examples of the alkali metal ion (b) include lithium, sodium, potassium, rubidium, and cesium ions, and the alkali metal ion (b) is preferably a sodium or potassium ion for industrial availability. In particular, by using a potassium ion, both hue of the resin composition (A) and interlayer adhesion of the resin composition (A) to a layer (Y) described later can be satisfied at high levels. One of those may be used alone, and alternatively two or more thereof may be used in combination; however, use of two or more of them in combination is preferable, and, in particular, containing a sodium ion and a potassium ion tends to result in improved interlayer adhesion and appearance.

Examples of an alkali metal compound that gives the alkali metal ion (b) include aliphatic carboxylic acid salts, aromatic carboxylic acid salts, carbonic acid salts, hydrochlorides, nitric acid salts, sulfuric acid salts, phosphoric acid salts, hydroxides, and metal complexes of an alkali metal such as lithium, sodium, and potassium. Among these, aliphatic carboxylic acid salts and phosphoric acid salts are more preferable for availability and handleability. Preferable aliphatic carboxylic acid salts include acetic acid salts, caprylic acid salts, and stearic acid salts.

The resin composition (A) may contain an additional component other than the modified EVOH (a), the EVOH (a′), and the alkali metal ion (b), as long as the effects of the present invention are not impaired. Examples of the additional component include an alkaline earth metal ion and transition metal ion, a carboxylic acid (a monocarboxylic acid, a polycarboxylic acid), a thermoplastic resin other than the modified EVOH (a) and the EVOH (a′), a phosphoric acid compound, a boron compound, a pro-oxidant, an antioxidant (e.g., a hindered phenolic compound), a plasticizer, a heat stabilizer (a melt stabilizer), a photoinitiator, a deodorant, a UV absorber, an antistatic, a lubricant, a colorant, a filler, a desiccant, a bulking agent, a pigment, a dye, a processing aid, a flame retardant, and an antifogging agent. Containing a carboxylic acid and/or a phosphoric acid compound is preferable because coloring can be prevented during melt-molding a crushed product of the multi-layer structure containing the resin composition (A). The melt viscosity of the resin composition (A) and that of a crushed product of the multi-layer structure containing the resin composition (A) can be controlled by containing a boron compound.

### <Alkaline Earth Metal Ion and Transition Metal Ion>

If containing an alkaline earth metal ion and transition metal ion, the resin composition (A) tends to be prevented from undergoing resin degradation and generation of degradation products such as gel in repeated melt-molding. The alkaline earth metal ion and transition metal ion are not limited, but a magnesium ion, a calcium ion, or a zinc ion is suitable. The alkaline earth metal ion and transition metal ion are preferably an alkaline earth metal salt and transition metal salt, and the anionic species of the alkaline earth metal salt and transition metal salt are not limited, either. The alkaline earth metal ion and transition metal ion can be added, for example, in the form of carboxylic acid salts, carbonic acid salts, hydrogen carbonates, phosphoric acid salts, hydrogen phosphates, hydrochlorides, nitric acid salts, sulfuric acid salts, boric acid salts, or hydroxides. If the resin composition (A) contains an alkaline earth metal ion and transition metal ion, the content is preferably 20 ppm or more and 300 ppm or less.

### <Carboxylic Acid>

The resin composition (A) preferably contains a carboxylic acid. The lower limit of the carboxylic acid content is preferably 50 ppm, and more preferably 100 ppm. The upper limit of the carboxylic acid content is preferably 400 ppm, and more preferably 350 ppm. A carboxylic acid content of 50 ppm or more tends to result in good coloring resistance. A carboxylic acid content of 400 ppm or less tends to result in successful maintenance of the interlayer adhesion and prevention of odor generation.

The pKa of the carboxylic acid is preferably 3.5 to 5.5. A pKa of the carboxylic acid within that range gives the resin composition (A) to be obtained enhanced pH-buffering ability, resulting in further improvement in melt-moldability and further improvement in coloring due to an acidic or basic substance.

The carboxylic acid may be any of monovalent carboxylic acids. One of these may be used alone, and alternatively two or more thereof may be used in combination. A monovalent carboxylic acid is a compound having one carboxyl group in the molecule. Examples of a monovalent carboxylic acid with a pKa in the range of 3.5 to 5.5 include, but are not limited to, formic acid (pKa=3.77), acetic acid (pKa=4.76), propionic acid (pKa=4.85), and acrylic acid (pKa=4.25). These carboxylic acids may further have a substituent such as a hydroxy group, an amino group, and a halogen atom. Among those, acetic acid is preferable because of its higher safety, availability, and handleability.

The carboxylic acid may be a polycarboxylic acid. If being a polycarboxylic acid, the carboxylic acid may allow further improvement in the coloring resistance of the resin composition (A) at high temperature and the coloring resistance of a melt-molded product of a crushed product of the multi-layer structure to be obtained. It is also preferable that the polycarboxylic acid compound has three or more carboxyl groups. In this case, more effective enhancement of coloring resistance can be achieved. A polycarboxylic acid is a compound having two or more carboxyl groups in the molecule. Here, the pKa of at least one carboxyl group is preferably in the range of 3.5 to 5.5, and examples include oxalic acid (pKa2=4.27), succinic acid (pKa1=4.20), fumaric acid (pKa2=4.44), malic acid (pKa2=5.13), glutaric acid (pKa1=4.30, pKa2=5.40), adipic acid (pKa1=4.43, pKa2=5.41), pimeric acid (pKa1=4.71), phthalic acid (pKa2=5.41), isophthalic acid (pKa2=4.46), terephthalic acid (pKa1=3.51, pKa2=4.82), citric acid (pKa2=4.75), tartaric acid (pKa2=4.40), glutamic acid (pKa2=4.07), and aspartic acid (pKa=3.90).

### <Phosphoric Acid Compound>

The resin composition (A) may further contain a phosphoric acid compound. The lower limit of the phosphoric acid compound content is preferably 5 ppm in terms of the phosphoric acid radical. The upper limit of the phosphoric acid compound content is preferably 100 ppm in terms of the phosphoric acid radical. By containing a phosphoric acid compound within the content range, the coloring of the resin composition (A) to be obtained and that of a melt-molded product of a crushed product of the multi-layer structure to be obtained can be prevented, and improved thermal stability can be given.

For example, any of various acids including phosphoric acid and phosphorous acid, or a salt thereof is used as the phosphoric acid compound. The phosphoric acid salt may be any of a monobasic phosphoric acid salt, a dibasic phosphoric acid salt, and a tribasic phosphoric acid salt. The cationic species of the phosphoric acid salt is not limited, either, and an alkali metal and an alkaline earth metal are preferable as the cationic species. Especially, sodium dihydrogen phosphate, potassium dihydrogen phosphate, disodium hydrogen phosphate, and dipotassium hydrogen phosphate are preferable as the phosphoric acid compound.

### <Boron Compound>

The resin composition (A) may further contain a boron compound. If the resin composition (A) contains a boron compound, the lower limit of the boron compound content of the resin composition (A) is preferably 50 ppm, and more preferably 100 ppm in terms of boron element. The upper limit of the boron compound content of the resin composition (A) is preferably 400 ppm, and more preferably 200 ppm in terms of boron element. By containing a boron compound within the content range, enhanced thermal stability can be given during melt-molding the resin composition (A) and a crushed product of the multi-layer structure to be obtained, resulting in prevention of the generation of gel and hard spots. Furthermore, improvement in draw-down resistance and in neck-in resistance during film formation and enhancement of the mechanical characteristics of a molded body to be obtained can be achieved. These effects are inferred to be due to generation of chelating interaction between the modified EVOH (a) and the boron compound.

Examples of the boron compound include boric acids, boric acid esters, boric acid salts, and boron hydrides. Specific examples include boric acids such as orthoboric acid (H₃BO₃), metaboric acid, and tetraboric acid; boric acid esters such as trimethyl borate and triethyl borate; and boric acid salts such as alkali metal salts or alkaline earth metal salts of the boric acids, and borax. Among these, orthoboric acid is preferable.

### <Hindered Phenolic Compound>

The resin composition (A) may further contain a hindered phenolic compound. If a hindered phenolic compound is contained, the hindered phenolic compound content of the resin composition (A) is preferably 1000 to 10000 ppm. With the content being 1000 ppm or more, the resin can be prevented from coloring, becoming more viscous, and gelling during melt-molding a crushed product of the multi-layer structure. The hindered phenolic compound content is more preferably 2000 ppm or more. With the hindered phenolic compound content being 10000 ppm or less, the coloring and bleed-out derived from the hindered phenolic compound can be prevented. The hindered phenolic compound content is more preferably 8000 ppm or less.

The hindered phenolic compound has at least one hindered phenol group. A hindered phenol group is a group in which a bulky substituent is bonded to at least one of the carbon atoms adjacent to the carbon to which the hydroxyl group of the phenol is bonded. The bulky substituent is preferably an alkyl group having 1 to 10 carbon atoms, and more preferably a t-butyl group.

The hindered phenolic compound is preferably in a solid state around room temperature. For preventing the bleed-out of the compound, the melting point or softening point of the hindered phenolic compound is preferably 50° C. or more, more preferably 60° C. or more, and further preferably 70° C. or more. For the same purpose, the molecular weight of the hindered phenolic compound is preferably 200 or more, more preferably 400 or more, and further preferably 600 or more. The molecular weight is normally 2000 or less. For facilitating mixing with the modified EVOH (a), the melting point or softening point of the hindered phenolic compound is preferably 200° C. or less, more preferably 190° C. or less, and further preferably 180° C. or less.

The hindered phenolic compound preferably has an ester bond or an amide bond. Examples of the hindered phenolic compound having an ester bond include esters of an aliphatic carboxylic acid having a hindered phenol group with an aliphatic alcohol, and examples of the hindered phenolic compound having an amide bond include amides of an aliphatic carboxylic acid having a hindered phenol group with an aliphatic amine. In particular, the hindered phenolic compound preferably has an amide bond.

Specific structures of the hindered phenolic compound having an ester bond or an amide bond include pentaerythritol tetrakis[3-(3,5-di-tert-butyl-4-hydroxyphenyl) propionate], which is commercially available from BASF as Irganox 1010; stearyl 3-(3,5-di-tert-butyl-4-hydroxyphenyl) propionate, which is commercially available as Irganox 1076; 2,2′-thiodiethyl bis[3-(3,5-di-tert-butyl-4-hydroxyphenyl) propionate], which is commercially available as Irganox 1035; octadecyl 3-(3,5-di-tert-butyl-4-hydroxyphenyl) propanoate, which is commercially available as Irganox 1135; ethylene bis(oxyethylene) bis(3-tert-butyl-4-hydroxy-5-methylbenzenepropanoate), which is commercially available as Irganox 245; 1,6-hexanediol bis[3-(3,5-di-tert-butyl-4-hydroxyphenyl) propionate], which is commercially available as Irganox 259; and N,N′-hexamethylene bis[3-(3,5-di-tert-butyl-4-hydroxyphenyl) propanamide], which is commercially available as Irganox 1098. Preferred among them are N,N′-hexamethylene bis[3-(3,5-di-tert-butyl-4-hydroxyphenyl) propanamide], which is commercially available as Irganox 1098, and pentaerythritol tetrakis[3-(3,5-di-tert-butyl-4-hydroxyphenyl) propionate], which is commercially available as Irganox 1010, and the former is more preferable.

The resin composition (A) may further contain a thermoplastic resin other than the modified EVOH (a) and the EVOH (a′). Examples of the thermoplastic resin other than the modified EVOH (a) and the EVOH (a′) include various polyolefins (e.g., polyethylene, polypropylene, poly(1-butene), poly(4-methyl-1-pentene), an ethylene-propylene copolymer, a copolymer of ethylene and an α-olefin having 4 or more carbon atoms, a copolymer of a polyolefin and maleic anhydride, an ethylene-vinyl ester copolymer, an ethylene-acrylate ester copolymer, or a modified polyolefin obtained by graft-modifying any of them with an unsaturated carboxylic acid or a derivative thereof), various polyamides (e.g., nylon 6, nylon 6-6, nylon 6/66 copolymer, nylon 11, nylon 12, poly(meta-xylylene adipamide)), various polyesters (e.g., polyethylene terephthalate, polybutylene terephthalate, polyethylene naphthalate), polyvinyl chloride, polyvinylidene chloride, polystyrene, polyacrylonitrile, polyurethane, polycarbonate, polyacetal, polyacrylate, and a modified polyvinyl alcohol resin. The thermoplastic resin content of the resin composition (A) is typically less than 40 mass %, preferably less than 30 mass %, more preferably less than 20 mass %, and further preferably less than 10 mass %, and may be less than 5 mass % or less than 1 mass %, and the resin composition (A) is particularly preferably substantially free of the thermoplastic resin.

For more prominent effects of the present invention, the proportion of the modified EVOH (a) in the resin constituting the resin composition (A) is preferably 60 mass % or more, more preferably 70 mass % or more, further preferably 80 mass %, furthermore preferably 90 mass % or more, and particularly preferably 95 mass % or more, and the proportion may be 98 mass % or more or 99 mass % or more, and the resin constituting the resin composition (A) may substantially consist of the modified EVOH (a). For more prominent effects of the present invention, the proportion of the modified EVOH (a) in the resin composition (A) is preferably 60 mass % or more, more preferably 70 mass % or more, further preferably 80 mass %, furthermore preferably 90 mass % or more, and particularly preferably 95 mass % or more, and the proportion may be 98 mass % or more or 99 mass % or more, and the resin composition (A) may substantially consist of the modified EVOH (a) and the alkali metal ion (b).

For achieving good gas barrier properties at low cost, the total of the modified EVOH (a) and EVOH (a′) contents of the resin constituting the resin composition (A) is preferably 70 mass % or more, more preferably 90 mass % or more, further preferably 95 mass % or more, and particularly preferably 99 mass % or more, and the resin constituting the resin composition (A) may substantially consist of the modified EVOH (a) and the EVOH (a′).

For achieving good gas barrier properties at low cost, the total of the modified EVOH (a) and EVOH (a′) contents of the resin composition (A) is preferably 70 mass % or more, more preferably 90 mass % or more, further preferably 95 mass % or more, and particularly preferably 99 mass % or more, and the resin composition (A) may substantially consist of the modified EVOH (a), the EVOH (a′), and the alkali metal ion (b).

For improved melt-moldability, the melt flow rate (MFR) (210° C., under a load of 2160 g) of the resin composition (A) as measured in accordance with a method described in JIS K7210 (2014) is preferably 0.1 to 30 g/10 min, more preferably 0.3 to 25 g/10 min, and further preferably 0.5 to 20 g/10 min.

Production of the resin composition (A) is not limited to a particular method, and the resin composition (A) can be produced by melt-kneading the modified EVOH (a) and the alkali metal ion (b), and, if necessary, additional components such as the EVOH (a′). These components may be blended in the original solid state such as powder or as a melt, or blended as a solute contained in a solution or a dispersoid contained in a dispersion. The solution and the dispersion are preferably an aqueous solution and an aqueous dispersion, respectively. Melt-kneading can be conducted by using a known mixing or kneading apparatus such as a kneader ruder, an extruder, a mixing roll, and a Banbury mixer. The temperature range in melt-kneading can be appropriately adjusted, for example, according to the melting points of the modified EVOH (a) and other components to be used, and a temperature range of 150 to 250° C. is typically employed. Alternatively, the production may be in such a manner that some components are preliminarily added to the modified EVOH (a) and the resultant is melt-kneaded with addition of other necessary components as described above. An exemplary method for preliminarily adding some components to the modified EVOH (a) is such that the modified EVOH (a) in the form of pellets or powder is immersed in a solution dissolving components to be added. An aqueous solution is suitable for the solution.

### <Adhesive Resin (B)>

The multi-layer film of the present invention includes a layer (Y) containing an adhesive resin (B) having a melting point of less than 150° C. as a main component. Through inclusion of the layer (Y), the multi-layer film of the present invention tends to be one excellent in appearance and interlayer adhesion. The adhesive resin (B) is, for example, a carboxylic-acid-modified polyolefin resin obtained by graft polymerization of a polyolefin resin with an unsaturated carboxylic acid such as maleic anhydride or a derivative thereof. The melting point of the adhesive resin (B) primarily depends on a polyolefin resin before carboxylic-acid modification. To the polyolefin resin, the contents of description of a polyethylene resin (C) shown later can be totally applied. Specifically, it is preferable that the adhesive resin (B) contain a carboxylic-acid-modified polyethylene resin as a main component, and it is more preferable that the adhesive resin (B) be a carboxylic-acid-modified polyethylene resin.

The proportion of a carboxylic-acid-modified polyolefin resin in the adhesive resin (B) is preferably 70 mass % or more, more preferably 80 mass % or more, and further preferably 95 mass % or more, and the adhesive resin (B) may substantially consist of a carboxylic-acid-modified polyolefin resin. The proportion of the adhesive resin (B) in the layer (Y) is preferably 70 mass % or more, more preferably 80 mass % or more, and further preferably 95 mass % or more, and the layer (Y) may substantially consist of the adhesive resin (B).

### <Polyethylene Resin (C)>

The multi-layer film of the present invention includes a layer (Z) containing a polyethylene resin (C) having a melting point of less than 150° C. as a main component. The polyethylene resin (C) may be any polyethylene having a melting point of less than 150° C. without limitation, and examples thereof include polyethylene resins such as linear low-density polyethylene, low-density polyethylene, medium-density polyethylene, and high-density polyethylene. Polyethylene resins are widely used for packaging materials irrespective of the presence or absence of gas barrier properties, and hence recycling infrastructures therefor have been extensively developed in many countries. The polyethylene resin (C) is preferably at least one selected from a linear low-density polyethylene, a low-density polyethylene, a medium-density polyethylene, and a high-density polyethylene, and more preferably at least one selected from a linear low-density polyethylene and a low-density polyethylene, or a mixture of a high-density polyethylene and at least one selected from a linear low-density polyethylene and a low-density polyethylene. The polyethylene resin (C) is preferably not carboxylic-acid-modified.

For more prominent effects of the present invention, the melting point of the polyethylene resin (C) is preferably less than 140° C., and more preferably less than 130° C. For process passability in melt-molding and secondary processing such as stretching and for thermal resistance necessary for a packaging material, the melting point of the polyethylene resin (C) is preferably 80° C. or more, and more preferably 90° C. or more. For improved melt-moldability, the melt flow rate (MFR) (210° C., under a load of 2160 g) of the polyethylene resin (C) as measured in accordance with a method described in JIS K7210 (2014) is preferably 0.1 to 30 g/10 min, more preferably 0.3 to 25 g/10 min, and further preferably 0.5 to 20 g/10 min.

The proportion of the polyethylene resin (C) in the layer (Z) is preferably 70 mass % or more, more preferably 80 mass % or more, and further preferably 95 mass % or more, and the layer (Z) may substantially consist of the polyethylene resin (C).

The layer (Y) and the layer (Z) contain, as a main component, the adhesive resin (B) and the polyethylene resin (C), respectively, and as long as the effects of the present invention are not impaired, those layers may contain other components such as an antioxidant, a plasticizer, a heat stabilizer (a melt stabilizer), a photoinitiator, a deodorant, a UV absorber, an antistatic, a lubricant, a colorant, a filler, a desiccant, a bulking agent, a pigment, a dye, a processing aid, a flame retardant, and an antifogging agent. However, the total amount of the components in each layer is less than 50 mass %, preferably less than 40 mass %, more preferably less than 30 mass %, further preferably less than 20 mass %, and particularly preferably less than 10 mass %.

### <Multi-Layer Film>

The multi-layer film of the present invention includes at least a layer (X), a layer (Y), and a layer (Z) adjacently layered in this order, with the layer (X) being an outermost layer. The multi-layer film may have a plurality of layers for each of the layer (X), the layer (Y), and the layer (Z). Examples of the layer configuration of the multi-layer film of the present invention include X/Y/Z, X/Y/Z/Y/X, and X/Y/Z/Y/X/Y/Z/Y/X, wherein X, Y, and Z denote the layer (X), the layer (Y), and the layer (Z), respectively, and “/” denotes being layered directly.

For gas barrier properties, recyclability, and economic efficiency, the thickness of the layer (X) of the multi-layer film of the present invention is preferably 0.2 μm or more and less than 20 μm. It is also preferable that the ratio of the thickness of the layer (X) to the total thickness of all layers of the multi-layer film be less than 25%. The thickness of the layer (X) is more preferably 0.4 μm or more and less than 16 μm, and further preferably 0.6 μm or more and less than 12 μm. The ratio of the thickness of the layer (X) to the total thickness of all layers of the multi-layer film is more preferably less than 20%, and further preferably less than 15%. The total thickness of all layers of the multi-layer film is typically 10 μm or more and less than 200 μm, and preferably 10 μm or more and less than 150 μm. For a stretched multi-layer film described later, the total thickness of all layers is preferably 10 μm or more and less than 50 μm, and more preferably less than 40 μm.

The multi-layer film of the present invention may be an unstretched multi-layer film, or a stretched multi-layer film that has been monoaxially or biaxially (at least monoaxially) stretched. Monaxial or biaxial stretching can impart improved mechanical properties and gas barrier properties to the resulting multi-layer film. The multi-layer film is preferably a monoaxially stretched multi-layer film for economic efficiency and ease in tearing the multi-layer film (when being used as a packaging material, the packaging material can be easily opened), and the multi-layer film is preferably a biaxially stretched multi-layer film for less isotropy in mechanical properties and achieving a tough film. Stretching at least monoaxially by 3 times or more and less than 12 times is preferable for the thickness uniformity and mechanical strength of the resulting multi-layer film. For a monoaxially stretched multi-layer film, stretching monoaxially by 3 times or more and less than 12 times is preferable, and stretching monoaxially by 4 times or more and less than 10 times is more preferable. For a biaxially stretched multi-layer film, stretching biaxially by 3 times or more and less than 12 times in each direction is preferable, and stretching biaxially by 4 times or more and less than 10 times in each direction is more preferable.

The formation of the multi-layer film of the present invention is not limited to a particular method, and typically a conventional co-extrusion method can be used in which individual resins are extruded from different dies or the same die and then layered. For the die(s), either an annular die or a T-die can be used. The monoaxial or biaxial stretching is not limited to a particular method, and the multi-layer film can be produced by performing stretching treatment in the film-flow direction and/or the direction perpendicular to the flow direction, that is, the width direction by a conventional known stretching method such as roll-type monoaxial stretching, tubular-type simultaneous biaxial stretching, tenter-type sequential biaxial stretching, and tenter-type simultaneous biaxial stretching. Especially, the effects of the present invention are particularly prominent for a multi-layer film produced by tenter-type sequential biaxial stretching. For processability, the temperature during stretching is typically 40 to 150° C., and more preferably 50 to 140° C., and may be 60 to 130° C. The multi-layer film of the present invention has an advantage that problems including defective appearance and deteriorated interlayer adhesion are less likely to arise after stretching even at a relatively low stretching temperature such as 120° C. After the stretching treatment, it is preferable to perform what is called heat fixation, in which the product is heated at a temperature equal to or higher than the glass transition temperature and lower than the melting point to increase the crystallinity and fix the orientation of molecular chains, if necessary.

### <Inorganic Vapor-Deposited Layer (I)>

The above problems are also solved by a vapor-deposited multi-layer film including an inorganic vapor-deposited layer (I) on an exposed surface side of the layer (X) of the multi-layer film of the present invention. The inorganic vapor-deposited layer (I) is a layer that is made of an inorganic material such as a metal and an inorganic oxide and exhibits gas barrier properties to oxygen and water vapor. The layer (X) has higher affinity with metals and inorganic oxides than common thermoplastic resins and can form a dense inorganic vapor-deposited layer (I) with no defect, and the resulting vapor-deposited multi-layer film has good interlayer adhesion between the layer (X) and the inorganic vapor-deposited layer (I). Furthermore, since the layer (X) has gas barrier properties, deterioration of gas barrier properties can be prevented even when defects are generated in the inorganic vapor-deposited layer (I) through bending or the like. The thickness of the inorganic vapor-deposited layer (I) is typically less than 500 nm. The thickness being less than 500 nm results in excellent stability of viscosity in melt-molding a crushed product of the multi-layer structure including the inorganic vapor-deposited layer (I), leading to prevention of the generation of gel and hard spots.

The inorganic vapor-deposited layer (I) is preferably either a metal vapor-deposited layer containing aluminum as a main component or an inorganic oxide vapor-deposited layer containing alumina or silica as a main component. A metal vapor-deposited layer is preferable if light-shielding ability is imparted, whereas an inorganic oxide vapor-deposited layer is preferable for content visibility and microwave suitability that are required for a packaging material, and for successful prevention of the generation of gel and hard spots in melt-molding a crushed product.

A metal vapor-deposited layer is a layer typically containing aluminum as a main component. The aluminum atom content of a metal vapor-deposited layer is preferably 50 mol % or more, more preferably 70 mol % or more, further preferably 90 mol % or more, and particularly preferably 95 mol % or more. The average thickness of a metal vapor-deposited layer is preferably 120 nm or less, more preferably 100 nm or less, and further preferably 90 nm or less. The average thickness of a metal vapor-deposited layer is preferably 25 nm or more, more preferably 35 nm or more, and further preferably 45 nm or more. Here, the average thickness of a metal vapor-deposited layer is the mean of thicknesses at 10 points arbitrarily selected in a cross-section of the metal vapor-deposited layer as measured with an electron microscope. Inclusion of a metal vapor-deposited layer allows the multi-layer film of the present invention to have light transmittance at a wavelength of 600 nm as low as 10% or less, giving excellent light-shielding ability.

Examples of an inorganic oxide vapor-deposited layer include vapor-deposited films of an inorganic oxide such as an oxide of silicon, aluminum, magnesium, calcium, potassium, tin, sodium, boron, titanium, lead, zirconium, or yttrium, preferably that of alumina or silica. The average thickness of an inorganic oxide vapor-deposited layer is preferably 60 nm or less, more preferably 50 nm or less, and further preferably 40 nm or less. The average thickness of an inorganic oxide vapor-deposited layer is preferably 10 nm or more, more preferably 15 nm or more, and further preferably 20 nm or more. Here, the average thickness of an inorganic oxide vapor-deposited layer is the mean of thicknesses at 10 points arbitrarily selected in a cross-section of the inorganic oxide vapor-deposited layer as measured with an electron microscope. Inclusion of an inorganic oxide vapor-deposited layer allows the multi-layer film of the present invention to have light transmittance at a wavelength of 600 nm as high as 80% or more, giving excellent content visibility when being used as a packaging material. For further improved visibility, the light transmittance at a wavelength of 600 nm is more preferably 90% or more. The light transmittance can be increased, for example, by reducing thickness irregularity in the multi-layer film of the present invention to be used for producing a vapor-deposited multi-layer film. The multi-layer film of the present invention tends to exhibit high light transmittance because the layer (X), which is included as an outermost layer, contains the modified EVOH (a) having a melting point of less than 150° C. as a main component and as a result has reduced thickness irregularity. An exemplary method for giving further reduced thickness irregularity to the multi-layer film of the present invention is a method of at least monoaxially stretching. The light transmittance of the multi-layer film of the present invention at a wavelength of 600 nm is preferably 80% or more, and more preferably 90% or more.

The inorganic vapor-deposited layer (I) can be formed by a known physical or chemical vapor deposition method. Specific examples include vacuum vapor deposition method, sputtering, ion plating, ion beam mixing, plasma CVD, laser CVD, MO-CVD, and thermal CVD, and physical vapor deposition is preferable, and among others, vacuum vapor deposition method is particularly preferable. As long as the effects of the present invention are not impaired, a protective layer (top coat layer) can be provided on the inorganic vapor-deposited layer (I), if necessary. The upper limit of the surface temperature of the layer (X) during forming the inorganic vapor-deposited layer (I) is preferably 60° C., more preferably 55° C., and further preferably 50° C. The lower limit of the surface temperature of the layer (X) during forming the inorganic vapor-deposited layer (I) is not limited, but is preferably 0° C., more preferably 10° C., and further preferably 20° C. Before the film formation, an exposed surface of the layer (X) may be plasma-treated. A known method can be used for the plasma treatment, and atmospheric-pressure plasma treatment is preferable. In the atmospheric-pressure plasma treatment, for example, nitrogen, helium, neon, argon, krypton, xenon, or radon is used as a discharge gas. Among these, nitrogen, helium, and argon are preferably used, and nitrogen is particularly preferable for cost reduction.

For the multi-layer film or vapor-deposited multi-layer film of the present invention, the oxygen transmission rate (under conditions of 20° C., 65% RH) is preferably less than 60 cc/(m²·day-atm), more preferably less than 40 cc/(m²·day-atm), further preferably less than 20 cc/(m²·day·atm), furthermore preferably less than 5 cc/(m²·day·atm), and particularly preferably less than 1 cc/(m²·day·atm) as measured in accordance with a method described in JIS K 7126-2 (equal-pressure method; 2006). The multi-layer film and vapor-deposited multi-layer film having an oxygen transmission rate in that range has excellent gas barrier properties.

### <Multi-Layer Structure>

Although being directly applicable as a packaging material having gas barrier properties, the multi-layer film or vapor-deposited multi-layer film of the present invention can be laminated with at least one resin layer (R) containing a thermoplastic resin (D) as a main component to provide a multi-layer structure endowed with various functions as a packaging material such as design and heat-sealing ability. Examples of the thermoplastic resin (D) include, but are not limited to, a homopolymer or copolymer of an olefin such as a linear low-density polyethylene, a low-density polyethylene, a medium-density polyethylene, a high-density polyethylene, a vinyl ester resin, an ethylene-propylene copolymer, polypropylene, a propylene-α-olefin copolymer (α-olefin having 4 to 20 carbon atoms), polybutene, and polypentene; polyamides such as nylon 6 and nylon 6,6; polyesters such as polyethylene terephthalate, polybutyrene terephthalate, and polyethylene naphthalate; polystyrene; polyvinyl chloride; polyvinylidene chloride; acrylic resins; polycarbonate; chlorinated polyethylene; and chlorinated polypropylene. Among these, polyolefin is preferable for excellent moisture resistance, mechanical properties, economic efficiency, and heat-sealing ability, and polyamide and polyester are preferable for excellent mechanical properties, thermal resistance, etc. For obtaining a multi-layer structure having particularly excellent recyclability, the thermoplastic resin (D) is preferably of the same type as the polyethylene resin (C) described above, that is, being a polyethylene resin having a melting point of less than 150° C. Therefore, for obtaining a multi-layer structure having excellent recyclability, it is preferable that the polyethylene resin (C) and the thermoplastic resin (D) be each a polyethylene resin. Such a resin layer (R) may be unstretched, or monoaxially or biaxially stretched or rolled. The resin layer (R) is preferably a biaxially stretched layer for enhanced mechanical strength, and preferably an unstretched layer for enhanced heat-seal ability.

The formation of the resin layer (R) is not limited to a particular method, and it is typically formed by melt-extrusion with an extruder. Either an annular die or a T-die can be used for the die. The monoaxial or biaxial stretching is not limited to a particular method, either, and the resin layer (R) can be produced by performing stretching treatment in the film-flow direction and/or the direction perpendicular to the flow direction, that is, the width direction by a conventional known stretching method such as roll-type monoaxial stretching, tubular-type simultaneous biaxial stretching, tenter-type sequential biaxial stretching, and tenter-type simultaneous biaxial stretching. The stretching ratio is preferably 8 to 60 times as an area magnification for the thickness uniformity and mechanical strength of the resulting layer. The area magnification is more preferably 55 times or less, and further preferably 50 times or less. The area magnification is more preferably 9 times or more. If the area magnification is less than 8 times, stretch unevenness may remain; if the area magnification is more than 60 times, the breaking of the layer may tend to occur during stretching.

The thickness of the resin layer (R) is preferably 10 to 200 μm for industrial productivity. Specifically, the thickness is more preferably 10 to 150 μm for an unstretched layer, and the thickness is more preferably 10 to 50 μm for a biaxially stretched layer.

The total thickness of the multi-layer structure of the present invention is preferably 300 μm or less. Having a total thickness within the range, the multi-layer structure of the present invention is lightweight and flexible, and hence preferably used in applications of soft packaging. Furthermore, the amounts of resins to be used for the multi-layer structure are small, resulting in reduced environmental loads.

The thickness of each layer in the multi-layer structure of the present invention can be appropriately adjusted according to its application, and the ratio of the total thickness of layers containing a polyethylene resin as a main component to the total thickness of the multi-layer structure is preferably 0.75 or more, and more preferably 0.85 or more for successful prevention of coloring during melt-molding a crushed product, improved thermal stability during melt-molding, and prevention of the generation of hard spots. On the other hand, the ratio is preferably 0.98 or less for enhanced gas barrier properties. Here, the layers containing a polyethylene resin as a main component are a layer containing a carboxylic-acid-modified polyethylene resin as a main component among the layer (Z) and the layer (Y), and a layer containing a polyethylene resin as a main component among the resin layers (R).

It is preferable that the multi-layer structure of the present invention include neither a layer containing a resin having a melting point of 240° C. or more as a main component nor a metal layer having a thickness of 1 μm or more. By virtue of the absence of a layer containing a resin having a melting point of 240° C. or more as a main component and a metal layer having a thickness of 1 μm or more, heterogeneous mixing of a crushed product of the multi-layer structure and other components can be prevented in melt-molding. Here, the metal layer is a layer having continuous and discontinuous surfaces made of metal such as aluminum foil. It is more preferable that the multi-layer structure of the present invention include no layer containing a resin having a melting point of 220° C. or more as a main component, and it is further preferable that the multi-layer structure of the present invention include no layer containing a resin having a melting point of 200° C. or more as a main component.

The lamination of a resin layer (R) on the multi-layer film of the present invention is not limited to a particular method, and examples include extrusion lamination, co-extrusion lamination, and dry-lamination. In laminating a resin layer (R) on the multi-layer film, an adhesive layer may be provided. That is, each layer constituting the multi-layer structure of the present invention may be laminated via an adhesive layer, if necessary. However, there is no adhesive layer between the layer (X) and the layer (Y) and between the layer (Y) and the layer (Z) in the multi-layer film. An adhesive layer can be formed by applying a known adhesive and then drying it. The adhesive is preferably a two-component reactive polyurethane adhesive, in which a polyisocyanate component and a polyol component are mixed and reacted. The thickness of each adhesive layer is preferably 1 to 5 μm, and more preferably 2 to 4 μm, but is not limited thereto.

The layer configuration of the multi-layer structure of the present invention is not limited, and, for example, layer configurations as shown below are preferable for obtaining a multi-layer structure excellent in recyclability. In the layer configurations below, X, Y, Z, I, and R denote the layer (X), the layer (Y), the layer (Z), the inorganic vapor-deposited layer (I), and a layer (R), respectively, “/” denotes being layered directly, and “//” denotes being layered via an adhesive layer.
(1) Z/Y/X//R
(2) Z/Y/X/I//R
(3) R//Z/Y/X//R
(4) R//Z/Y/X/I//R

In the layer configurations, the layer (X), the layer (Y), and the layer (Z) are preferably at least monoaxially stretched, and more preferably biaxially stretched. Each of the layer (Z) and the layer(s) (R) is preferably made of a polyethylene resin, and the layer (Y) is preferably made of a maleic-anhydride-modified polyethylene resin.

As long as the effects of the present invention are not impaired, the multi-layer structure of the present invention may include an additional layer other than those described above. An example of the additional layer is a recycled layer. In particular, it is preferable to reuse a recycled composition containing a recycled material from the multi-layer structure of the present invention, which is described later, as a part or the whole of the recycled layer. Another example of the additional layer is a printed layer. A printed layer may be included at any position in the multi-layer structure of the present invention. An exemplary printed layer is a coating film obtained by applying a solution containing, for example, a pigment or dye, and, if necessary, a binder resin and then drying it. Examples of application methods for printed layers include gravure printing, and various application methods with a wire bar, a spin coater, a die coater, or the like. The thickness of an ink layer is preferably 0.5 to 10 μm, and more preferably 1 to 4 μm, but is not limited thereto.

It is preferable to reuse a recycled material (scrap) obtained by collecting offcuts and/or defective products generated in producing the multi-layer structure of the present invention. A method for recycling a multi-layer structure, wherein the multi-layer structure of the present invention is crushed and then melt-molded, and a recycled composition containing a recycled material from the multi-layer structure of the present invention are also preferred embodiments of the present invention.

In recycling of the multi-layer structure of the present invention, first, a recycled material from the multi-layer structure of the present invention is crushed. The crushed recycled material may be melt-molded as it is to provide a recycled composition, or, if necessary, melt-molded with an additional component to provide a recycled composition. A preferable component to be added to the recycled material is a polyethylene resin. The polyethylene resin to be used is of the same type as the polyethylene resin (C) described above as a polyethylene resin to be used for the multi-layer film of the present invention. The crushed recycled material may be directly used for production of a molded article such as a multi-layer structure; alternatively, pellets of the recycled composition may be obtained by melt-molding the crushed recycled material and then used for production of a molded article.

The mass ratio of the resin composition (A) to the polyethylene resin [resin composition (A)/polyethylene resin] in the recycled composition is preferably 0.01/99.99 to 20/80. If the mass ratio is less than 0.01/99.99, a lower recycled material use rate may result. If the mass ratio is more than 20/80, on the other hand, the recycled composition may have deteriorated melt-moldability and mechanical properties. For achieving enhanced melt-moldability and mechanical properties in the recycled composition to be obtained, the mass ratio is preferably 15/85 or less, and more preferably 10/90 or less, and may be 5/95 or less.

Having excellent appearance, gas barrier properties, and recyclability, the multi-layer structure of the present invention can be suitably used as a material for various kinds of packaging such as food packaging, pharmaceutical packaging, industrial chemical packaging, and agrochemical packaging. In particular, a packaging material including the multi-layer structure of the present invention can be suitably used as a packaging material excellent in recyclability.

### EXAMPLES

Hereinafter, the present invention will be specifically described with reference to Examples, but the present invention is not limited at all by those Examples.

### Example 1

### (1) Production of Resin Composition (A) Containing Modified EVOH (a)

28 parts by mass of zinc acetylacetonate monohydrate and 957 parts by mass of 1,2-dimethoxyethane were mixed to give a mixed solution. To the resulting mixed solution was added 15 parts by mass of trifluoromethanesulfonic acid with stirring to give a catalyst solution. Subsequently, EVOH having an ethylene unit content of 44.0 mol % and a degree of saponification of 99.9 mol % or more (here, containing no alkali metal ion) was charged into the extruder TEM-35BS (37 mmφ, L/D=52.5) manufactured by Toshiba Machine Co., Ltd., and the extruder was operated under the following conditions: a barrel C1 under water cooling; barrels C2 and C3 at 200° C.; barrels C4 to C15 at 240° C.; and a screw rotation frequency of 250 rpm. From a pressure inlet 1 of the C8, epoxypropane (1.5 kg/hr) and the catalyst solution were added. From a pressure inlet 2 of the C13, an aqueous solution of a mixture of sodium acetate and potassium acetate was then added. The discharged strand was cooled to solidify in a cooling tank, and then cut to give resin composition (A1) pellets. In the present step, the amount of the catalyst solution added was adjusted to allow the modified EVOH to have a melting point of 119° C. The amount of the aqueous solution of a mixture of sodium acetate and potassium acetate added was appropriately adjusted to allow the resin composition (A1) pellets to have an alkali metal ion (b) content shown in Table 1.

The resulting resin composition (A1) pellets were dissolved in dimethyl sulfoxide (DMSO)-d6 containing tetramethylsilane as an internal standard, and subjected to measurement with a 500 MHz 1H-NMR spectrometer (“GX-500” manufactured by JEOL Ltd.) at 80° C. Analysis of the acquired spectrum found the epoxy modification unit (a modifying group represented by the above general formula (I), wherein R¹ and R² are each a hydrogen atom, and one of R³ and R⁴ is a hydrogen atom and the other is a methyl group) content to be 4.6 mol %.

### (2) Melting Point of Resin Composition (A1) Pellets

The resin composition (A1) pellets obtained in the (1) were warmed from 20° C. to 220° C. at a rate of 10° C./min with a differential scanning calorimeter (“Q2000” manufactured by TA Instruments), then cooled to 20° C. at a rate of 10° C./min, and again warmed from 20° C. to 220° C. at a rate of 10° C./min. The temperature at which a local maximum value of an endothermic peak was reached in the second warming was determined as the melting point. The melting point of the resin composition (A1) was found to be 119° C. It should be noted that the melting point of the resin composition (A1) pellets is the same as the melting point of the modified EVOH constituting the resin composition (A1) pellets.

### (3) Alkali Metal Ion (b) Contents of Resin Composition (A1) Pellets

In a Teflon (R) pressure vessel, 0.5 g of the resin composition (A1) pellets obtained in the (1) was placed, and 5 mL of concentrated nitric acid was added thereto to allow decomposition at room temperature for 30 minutes. After the decomposition, a lid was put on the vessel, and the mixture was heated with a wet decomposer (“MWS-2” manufactured by ACTAC Co., Ltd.) at 150° C. for 10 minutes and then at 180° C. for 5 minutes for further decomposition, and then cooled to room temperature. This treated solution was transferred to a 50-mL measuring flask and diluted with pure water to the specified volume. This solution was analyzed with an ICP emission spectrophotometer (“Optima 4300DV” manufactured by PerkinElmer Co., Ltd.) to determine the alkali metal ion (b) contents. For the alkali metal ion (b) contents, the sodium ion content was 30 ppm and the potassium ion content was 15 ppm.

### (4) Yellow Index of Resin Composition (A1) Pellets

The yellow index (YI) of the resin composition (A1) pellets obtained in the (1) was determined by using a spectral colorimeter (“LabScan XE Sensor” manufactured by HunterLab), and rated in accordance with criteria shown below. The YI value is an index indicating yellowness of an object. Higher YI values indicate higher yellow index, and lower YI values indicate lower yellow index, and thus less coloring.

### Rating: Criteria

A: less than 15
B: 15 or more and less than 25
C: 25 or more and less than 35
D: 35 or more and less than 45
E: 45 or more

### (5) Thermal Decomposition Temperature of Resin Composition (A1) Pellets

The resin composition (A1) pellets obtained in the (1) were warmed from 20° C. to 600° C. at a rate of 10° C./min under a nitrogen atmosphere with a thermogravimetry apparatus (“Q2000” manufactured by TA instruments), and rated in accordance with criteria shown below on the temperature at which the mass was reduced to 95% of the original mass.

### Rating: Criteria

A: 360° C. or higher
B: 350° C. or higher and lower than 360° C.
C: 340° C. or higher and lower than 350° C.
D: 330° C. or higher and lower than 340° C.
E: lower than 330° C.

### (6) Production of Mono-Layer Film of Resin Composition (A1)

Single-layer film formation was conducted with the resin composition (A1) pellets obtained in the (1) through the 20-mm extruder “D2020” (D (mm)=20, L/D=20, compression ratio=2.0, screw: full-flight) manufactured by Toyo Seiki Seisaku-sho, Ltd. under conditions shown below, giving a mono-layer film (thickness: 20 μm) of the resin composition (A1).

Cylinder Temperature: 160° C. At Feeding Section, 190° C. At Compressing section, 190° C. At Measuring Section
Die temperature: 190° C.
Screw rotation frequency: 40 rpm
Discharging rate: 1.0 to 1.1 kg/hr
Take-up roll temperature: 50° C.
Take-up roll speed: 3.0 m/min
Film thickness: 20 μm

In other Examples in the present specification, temperature conditions for the extruder were set according to the melting point of the modified EVOH as follows.

### Cylinder Temperature:

Feeding section: 160° C.
Compressing section: melting point of modified EVOH+4 to 80° C.
Measuring section: melting point of modified EVOH+40 to 80° C.
Die temperature: melting point of modified EVOH+40 to 80° C.

### (7) Oxygen Transmission Rate of Mono-Layer Film of Resin Composition (A1)

The oxygen transmission rate of the mono-layer film of the resin composition (A1) obtained in the (6) was measured in accordance with a method described in JIS K 7126-2 (equal-pressure method; 2006). Specifically, by using an oxygen transmission analyzer (“MOCON OX-TRAN2/21” manufactured by Modern Controls Inc.), the oxygen transmission rate (unit: cc/(m²·day-atm)) was measured under conditions of temperature: 20° C., humidity in oxygen-feeding side: 65% RH, humidity in carrier gas side: 65% RH, oxygen pressure: 1 atm, and carrier gas pressure: 1 atm, and rated in accordance with criteria shown below. The carrier gas was nitrogen gas containing 2 vol % of hydrogen gas. The result is shown in Table 1. The rating D indicates being unacceptable.

### Rating: Criteria

A: less than 5 cc/(m²·day·atm)
B: 5 cc/(m²·day·atm) or more and less than 10 cc/(m²·day-atm)
C: 10 cc/(m²·day·atm) or more and less than 15 cc/(m²·day·atm)
D: 15 cc/(m²·day·atm) or more

### (8) Production of Unstretched Multi-Layer Film

With the resin composition (A1) pellets obtained in the (1), a polyethylene resin (“Innate™ TF80” manufactured by The Dow Chemical Company; low-density polyethylene, melting point: 122° C.), and a polyethylene adhesive resin (“Amplify™ TY1353” manufactured by The Dow Chemical Company; linear low-density polyethylene adhesive resin graft-modified with maleic anhydride, melting point: 124° C.), a three-material three-layer unstretched multi-layer film (resin composition (A1)/polyethylene adhesive resin/polyethylene resin=X/Y/Z=50 μm/25 μm/225 μm) was formed. The thickness of the co-extruded film was adjusted by appropriately changing the screw rotation frequency and take-up roll speed.

The extruder, extrusion conditions, and die used were as follows.

### Resin Composition (A1)

Extruder: single-screw extruder (TOYO SEIKI Co., Ltd., Labo Machine Model ME CO-EXT)
Screw: diameter 20 mmq, L/D 20, full-flight screw
Extrusion temperature: feeding section/compressing section/measuring section/die=175/190/200/200° C.

### Polyethylene Adhesive Resin

Extruder: single-screw extruder (TECHNOVEL Corporation, SZW20GT-20 MG-STD)
Screw: diameter 20 mmφ, L/D 20, full-flight screw
Extrusion temperature: feeding section/compressing section/measuring section/die=175/200/220/220° C.

### Polyethylene Resin

Extruder: single-screw extruder (Research Laboratory of Plastics Technology Co., Ltd. GT-32-A)
Screw: diameter 32 mmq, L/D 28, full-flight screw
Extrusion temperature: feeding section/compressing section/measuring section/die=175/200/220/220° C.
Die: coat-hanger die for three-material three-layer film of 300 mm in width (Research Laboratory of Plastics Technology Co., Ltd.)
Die temperature: 220° C.

### (9) Production of Biaxially Stretched Multi-Layer Film

With tenter-type sequential biaxial stretching equipment, the unstretched multi-layer film obtained in the (8) was stretched by three times in the MD direction and then by three times in the TD direction at 125° C. to provide a three-material three-layer biaxially stretched multi-layer film (resin composition (A1)/polyethylene adhesive resin/polyethylene resin=X/Y/Z=5.5 μm/2.8 μm/25 μm).

### (10) Production of Vapor-Deposited Biaxially Stretched Multi-Layer Film

On the surface of the resin composition (A1) layer (layer (X)) of the biaxially stretched multi-layer film obtained in the (9), aluminum metal was vapor-deposited to a thickness of 50 nm by a known vacuum vapor deposition method to give a metal-vapor-deposited biaxially stretched multi-layer film (Al/resin composition (A1)/polyethylene adhesive resin/polyethylene resin=I/X/Y/Z=50 nm/5.5 μm/2.8 μm/25 μm).

### (11) Production of Multi-Layer Structure

On one surface of an unstretched polyethylene film (“Unilax™ LS-760C” manufactured by Idemitsu Unitech Co., Ltd., melting point: 127° C., thickness: 50 μm), a two-component adhesive (“Takelac™ A-520” and “Takenate™ A-50” manufactured by Mitsui Chemicals Inc.) was applied and dried to reach a dry thickness of 2 μm, and laminated on the vapor-deposited surface of the metal-vapor-deposited biaxially stretched multi-layer film obtained in the (10) to provide a multi-layer structure (PE/adhesive/Al/resin composition (A1)/polyethylene adhesive resin/polyethylene resin=R/adhesive/I/X/Y/Z=50 μm/2 μm/50 nm/5.5 μm/2.8 μm/25 μm).

### (12) Evaluation of Interlayer Adhesion

The multi-layer structure obtained in the (11) was humidity-controlled at 23° C. and 50% RH, and then cut into a sample with a length of 150 mm along the extrusion direction and a width of 15 mm. With use of the autograph “DCS-50M type tensile testing machine” manufactured by Shimadzu Corporation, the peel strength of the sample was measured by peeling under an atmosphere of 23° C. and 50% RH in a T-type peeling mode at a tensile speed of 250 mm/min, and rated in accordance with criteria shown below. Here, the peeling interface was the Al/resin composition (A1) interface or the resin composition (A1)/polyethylene adhesive resin interface. The result is shown in Table 1. The rating E indicates being unacceptable.

### Rating: Criteria

A: 250 g/15 mm or more
B: 200 g/15 mm or more and less than 250 g/15 mm
C: 150 g/15 mm or more and less than 200 g/15 mm
D: 100 g/15 mm or more and less than 150 g/15 mm
E: less than 100 g/15 mm

### (13) Evaluation of Sequential Biaxial Stretchability of Multi-Layer Film

### (Evaluation of Appearance)

With tenter-type sequential biaxial stretching equipment, the unstretched multi-layer film obtained in the (8) was stretched by three times in the MD direction and then by three times in the TD direction at 125° C. to provide a three-material three-layer biaxially stretched multi-layer film at a stretching ratio of 3×3 (resin composition (A1)/polyethylene adhesive resin/polyethylene resin=X/Y/Z=5.5 μm/2.8 μm/25 μm). With tenter-type sequential biaxial stretching equipment, the unstretched multi-layer film obtained in the (8) was stretched by four times in the MD direction and then by four times in the TD direction at 125° C. to provide a three-material three-layer biaxially stretched multi-layer film at a stretching ratio of 4×4 (resin composition (A1)/polyethylene adhesive resin/polyethylene resin=X/Y/Z=3.1 μm/1.6 μm/14.1 μm).

The appearance of each of the resulting multi-layer films after stretching was visually observed, and rated in accordance with criteria shown below. The results are shown in Table 1. The rating E indicates being unacceptable.

### Rating: Criteria

### Sequential Stretchability (3×3)

A: the sequential stretching at a stretching ratio of 3×3 succeeded, and uniform appearance with no unevenness resulted
B: the sequential stretching at a stretching ratio of 3×3 succeeded, but slight unevenness and/or streaks were found
C: the sequential stretching at a stretching ratio of 3×3 succeeded, but unevenness and/or streaks were found
D: the sequential stretching at a stretching ratio of 3×3 succeeded, but significant unevenness and/or streaks were found
E: the sequential stretching at a stretching ratio of 3×3 did not succeed, and cracks were found

### Sequential Stretchability (4×4)

A: the sequential stretching at a stretching ratio of 4×4 succeeded, and uniform appearance with no unevenness resulted
B: the sequential stretching at a stretching ratio of 4×4 succeeded, but slight unevenness and/or streaks were found
C: the sequential stretching at a stretching ratio of 4×4 succeeded, but unevenness and/or streaks were found
D: the sequential stretching at a stretching ratio of 4×4 succeeded, but significant unevenness and/or streaks were found
E: the sequential stretching at a stretching ratio of 4×4 did not succeed, and cracks were found

### (14) Evaluation of Blocking Resistance

The center part of the unstretched multi-layer film obtained in the (8) was cut to prepare a sample of 100 mm×100 mm, the sample was stretched by four times in the MD direction and then by four times in the TD direction at 125° C. with use of a biaxial-stretching birefringence analyzer (manufactured by ETO Co., Ltd., model: SDR-506WK) (five stretching chucks in each side, one stretching chuck at each angle, 24 stretching chucks in total, length and width of each chuck: 10 mm and 6.5 mm, respectively), and, among the 24 stretching chucks, the number of stretching chucks with attachment of the melted film was counted to evaluate the avoidance of the attachment of the melted resin to the chucks, that is, the blocking resistance. The result is shown in Table 1. The rating D indicates being unacceptable.

### Rating: Criteria

A: 5 or less
B: 6 or more and 10 or less
C: 11 or more and 15 or less
D: 16 or more

### Examples 2 to 18 and Comparative Examples 3, 5, 6

Pellets of resin compositions (A2) to (A18), (AC3), (AC5), and (AC6) were produced and evaluated in the same manner as in Example 1, except that the ethylene unit content, the type of the modifying agent, the modifying group content, and the alkali metal ion (b) content were changed as shown in Table 1. The results are shown in Table 1. The modifying group content and alkali metal ion content were adjusted by appropriately adjusting the amount of a modifying agent to be added, the amount of a catalyst to be added, and the concentration and amount of an alkali-metal-ion-containing aqueous solution to be added.

### Comparative Examples 1, 2

Pellets of resin compositions (AC1) and (AC2) were obtained and evaluated in the same manner as in Example 1, except that the catalyst solution and epoxypropane were not added in the (1) and the ethylene unit content and the alkali metal ion (b) content were changed as shown in Table 1. The results are shown in Table 1.

### Comparative Example 4

After dry-blending 80 parts by mass of the resin composition (AC2) pellets obtained in Comparative Example 2 and 20 parts by mass of the resin composition (AC3) pellets obtained in Comparative Example 3, melt-extrusion was conducted by using the twin-screw extruder “TEX30a” (screw diameter: 30 mm) manufactured by Japan Steel Works, Ltd. with a screw having a forward staggered kneading disk with L (screw length)/D (screw diameter)=3 under conditions of melting temperature: 210 to 220° C. and extrusion speed: 20 kg/hr, and a discharged strand was cooled to solidify in a cooling tank, and then cut to give resin composition (AC4) pellets. Evaluation was performed in the same manner as in Example 1 except that the resulting resin composition (AC4) pellets were used. The results are shown in Table 1.

TABLE 1

| | Resin composition (A) | | | | | | | | | | | | | | | | | | |
|---|---|---|---|---|---|---|---|---|---|---|---|---|---|---|---|---|---|---|---|
| | | EVOH(a) | | | | | EVOH(a′) | | | | | | Evaluation | | | | | | |
| | | | Ethylene | Degree | | Modifying | | Ethylene | Degree | | Alkali | | | Thermal | Inter- | Sequential | Sequential | | Oxygen |
| | | Melting | unit | of sponi- | Modi- | group | Melting | unit | of sponi- | Mass | metal ions (b) | | | decom- | layer | stretch- | stretch- | | trans- |
| | | point | content | fication | fying | content | point | content | fication | ratio | | Contents | | position | ad- | ability | ability | Blocking | mission |
| | Type | (° C.) | (mol %) | (mol %) | agent¹⁾ | (mol %) | (° C.) | (mol %) | (mol %) | (a/a′) | Type | (ppm) | Hue | temperature | hesion | (3 × 3) | (4 × 4) | resistances | rate |
| Example 1 | A1 | 119 | 44 | ≥99.9 | 1 | 4.6 | — | — | — | 100/0 | Na + K | 30 + 15 | B | A | A | A | B | C | C |
| Example 2 | A2 | 122 | 44 | ≥99.9 | 1 | 4.0 | — | — | — | 100/0 | Na + K | 30 + 15 | B | A | A | A | A | B | B |
| Example 3 | A3 | 130 | 44 | ≥99.9 | 1 | 3.0 | — | — | — | 100/0 | Na + K | 30 + 15 | B | A | A | A | B | A | B |
| Example 4 | A4 | 133 | 44 | ≥99.9 | 1 | 2.9 | — | — | — | 100/0 | Na + K | 30 + 15 | A | A | A | B | C | A | B |
| Example 5 | A5 | 122 | 44 | ≥99.9 | 1 | 4.0 | — | — | — | 100/0 | Na + K | 8 + 15 | A | A | C | B | C | B | B |
| Example 6 | A6 | 122 | 44 | ≥99.9 | 1 | 4.0 | — | — | — | 100/0 | Na + K | 20 + 15 | B | A | B | A | A | B | B |
| Example 7 | A7 | 122 | 44 | ≥99.9 | 1 | 4.0 | — | — | — | 100/0 | Na + K | 80 + 15 | C | A | A | A | A | B | B |
| Example 8 | A8 | 122 | 44 | ≥99.9 | 1 | 4.0 | — | — | — | 100/0 | Na + K | 250 + 15 | C | B | A | A | A | B | B |
| Example 9 | A9 | 122 | 44 | ≥99.9 | 1 | 4.0 | — | — | — | 100/0 | Na + K | 600 + 15 | D | B | A | B | C | B | B |
| Example 10 | A10 | 122 | 44 | ≥99.9 | 1 | 4.0 | — | — | — | 100/0 | Na + K | 900 + 15 | D | C | A | C | D | B | B |
| Example 11 | A11 | 122 | 44 | ≥99.9 | 1 | 4.0 | — | — | — | 100/0 | Na | 45 | B | A | B | B | C | B | B |
| Example 12 | A12 | 122 | 44 | ≥99.9 | 2 | 4.9 | — | — | — | 100/0 | Na + K | 30 + 15 | B | A | A | A | A | B | B |
| Example 13 | A13 | 122 | 44 | ≥99.9 | 2 | 4.9 | — | — | — | 100/0 | Na + K | 20 + 15 | B | B | B | A | A | B | B |
| Example 14 | A14 | 127 | 44 | ≥99.9 | 2 | 4.3 | — | — | — | 100/0 | Na + K | 20 + 15 | B | B | B | B | C | B | B |
| Example 15 | A15 | 136 | 44 | ≥99.9 | 2 | 3.0 | — | — | — | 100/0 | Na + K | 20 + 15 | B | B | B | B | C | A | B |
| Example 16 | A16 | 149 | 44 | ≥99.9 | 2 | 2.0 | — | — | — | 100/0 | Na + K | 20 + 15 | B | B | B | C | D | A | A |
| Example 17 | A17 | 122 | 32 | ≥99.9 | 1 | 8.0 | — | — | — | 100/0 | Na + K | 80 + 15 | C | C | C | B | C | A | A |
| Example 18 | A18 | 132 | 32 | ≥99.9 | 1 | 5.5 | — | — | — | 100/0 | Na + K | 80 + 15 | C | C | C | C | C | A | A |
| Comparative | AC1 | 124 | 69 | ≥99.9 | — | — | — | — | — | 100/0 | Na + K | 250 + 15 | C | C | A | A | A | B | D |
| Example 1 | | | | | | | | | | | | | | | | | | | |
| Comparative | AC2 | 165 | 44 | ≥99.9 | — | — | — | — | — | 100/0 | Na + K | 250 + 15 | C | C | E | E | E | A | A |
| Example 2 | | | | | | | | | | | | | | | | | | | |
| Comparative | AC3 | 108 | 44 | ≥99.9 | 1 | 5.3 | — | — | — | 100/0 | Na + K | 30 + 15 | B | B | B | B | C | D | D |
| Example 3 | | | | | | | | | | | | | | | | | | | |
| Comparative | AC4 | 108 | 44 | ≥99.9 | 1 | 5.3 | 165 | 44 | ≥99.9 | 20/80 | Na + K | 30 + 15 | B | B | B | E | E | A | A |
| Example 4 | | | | | | | | | | | | | | | | | | | |
| Comparative | AC5 | 122 | 44 | ≥99.9 | 1 | 4.0 | — | — | — | 100/0 | Na + K | 1600 | E | C | A | E | E | B | B |
| Example 5 | | | | | | | | | | | | | | | | | | | |
| Comparative | AC6 | 122 | 44 | ≥99.9 | 1 | 4.0 | — | — | — | 100/0 | Na + K | 2 + 15 | A | A | E | E | E | B | B |
| Example 6 | | | | | | | | | | | | | | | | | | | |

¹⁾Modifying agent 1: Epoxypropane Modifying agent 2: 1,2-Epoxybutane

### Example 19

### (1) Production of Multi-Layer Film

With the resin composition (A2) pellets obtained in Example 2, a polyethylene resin (“Innate™ TF80” manufactured by The Dow Chemical Company; low-density polyethylene, melting point: 122° C.), and a polyethylene adhesive resin (“Amplify™ TY1353” manufactured by The Dow Chemical Company; linear low-density polyethylene adhesive resin graft-modified with maleic anhydride, melting point: 124° C.), a three-material three-layer unstretched multi-layer film (resin composition (A2)/polyethylene adhesive resin/polyethylene resin=X/Y/Z=2 μm/2 μm/16 μm) was formed by using the same extruder under the same temperature conditions as in Example 2. The thickness of the co-extruded film was adjusted by appropriately changing the screw rotation frequency and the take-up roll speed.

### (2) Oxygen Transmission Rate of Multi-Layer Film Before and After Bending Treatment

The oxygen transmission rate of the multi-layer film obtained in the (1) was measured in accordance with a method described in JIS K 7126-2 (equal-pressure method; 2006) with the resin composition layer and the polyethylene resin layer positioned in the oxygen-feeding side and in the carrier gas side, respectively. Specifically, by using an oxygen transmission analyzer (“MOCON OX-TRAN2/21” manufactured by Modern Controls Inc.), the oxygen transmission rate (unit: cc/(m²·day·atm)) was measured under conditions of temperature: 20° C., humidity in oxygen-feeding side: 65% RH, humidity in carrier gas side: 65% RH, oxygen pressure: 1 atm, and carrier gas pressure: 1 atm, and rated in accordance with criteria shown below. The carrier gas was nitrogen gas containing 2 vol % of hydrogen gas. The multi-layer film was humidity-controlled under an atmosphere of 23° C. and 50% RH, and then subjected to bending treatment by using a Gelvo Flex Tester (manufactured by Rigaku Kogyo Co., Ltd.), and the oxygen transmission rate thereafter was measured, too. Specifically, first, the multi-layer film was formed into a cylinder of 3.5 inches in diameter, and, with the ends gripped, the multi-layer film was subjected to 10 cycles of reciprocating motion at a speed of 30 cycles/min, each cycle consisting of repeated movement between an initial grip interval of 7 inches and a grip interval of 1 inch at the maximum bending with twisting up to an angle of 330° in the initial 3.5 inches of each stroke and straight horizontal motion in the subsequent 2.5 inches, and the oxygen transmission rate was then measured with the same method as above. The result is shown in Table 2.

### Rating: Criteria

A: less than 1 cc/(m²·day·atm)
B: 1 cc/(m²·day·atm) or more and less than 5 cc/(m²·day·atm)
C: 5 cc/(m²·day·atm) or more and less than 20 cc/(m²·day·atm)
D: 20 cc/(m²·day·atm) or more and less than 30 cc/(m²·day·atm)
E: 30 cc/(m²·day·atm) or more and less than 60 cc/(m²·day·atm)
F: 60 cc/(m²·day·atm) or more and less than 100 cc/(m²·day·atm)
G: 100 cc/(m²·day·atm) or more

### Example 20

A three-material three-layer unstretched multi-layer film (resin composition (A2)/polyethylene adhesive resin/polyethylene resin=10 μm/5 μm/5 μm) was formed and evaluated in the same manner as in Example 19, except that the extrusion conditions were changed. The results are shown in Table 2.

### Example 21

A three-material three-layer unstretched multi-layer film (resin composition (A2)/polyethylene adhesive resin/polyethylene resin=8 μm/8 μm/63 μm) was formed in the same manner as in Example 19, except that the extrusion conditions were changed. Subsequently, with tenter-type sequential biaxial stretching equipment, the unstretched multi-layer film was stretched by four times in the MD direction at 125° C. to produce a three-material three-layer monoaxially stretched multi-layer film (resin composition (A2)/polyethylene adhesive resin/polyethylene resin=2 μm/2 μm/16 μm), which was evaluated in the same manner as in Example 19. The results are shown in Table 2.

### Example 22

A three-material three-layer unstretched multi-layer film (resin composition (A2)/polyethylene adhesive resin/polyethylene resin=8 μm/8 μm/63 μm) was formed in the same manner as in Example 19, except that the extrusion conditions were changed. Subsequently, with tenter-type sequential biaxial stretching equipment, the unstretched multi-layer film was stretched by four times in the TD direction at 125° C. to produce a three-material three-layer monoaxially stretched multi-layer film (resin composition (A2)/polyethylene adhesive resin/polyethylene resin=2 μm/2 μm/16 μm), which was evaluated in the same manner as in Example 19. The results are shown in Table 2.

### Example 23

A three-material three-layer unstretched multi-layer film (resin composition (A2)/polyethylene adhesive resin/polyethylene resin=32 μm/32 μm/256 μm) was formed in the same manner as in Example 19, except that the extrusion conditions were changed. Subsequently, with tenter-type sequential biaxial stretching equipment, the unstretched multi-layer film was stretched by four times in the MD direction and then by four times in the TD direction at 125° C. to produce a three-material three-layer biaxially stretched multi-layer film (resin composition (A2)/polyethylene adhesive resin/polyethylene resin=2 μm/2 μm/16 μm), which was evaluated in the same manner as in Example 19. The results are shown in Table 2.

### Example 24

On the surface of the resin composition layer of the three-material three-layer biaxially stretched multi-layer film produced in Example 23, aluminum metal was vapor-deposited to a thickness of 50 nm by a known vacuum vapor deposition method to produce a metal-vapor-deposited biaxially stretched multi-layer film (Al/resin composition (A2)/polyethylene adhesive resin/polyethylene resin=50 nm/2 μm/2 μm/16 μm), which was evaluated in the same manner as in Example 19. The results are shown in Table 2.

### Example 25

On the surface of the resin composition layer of the three-material three-layer biaxially stretched multi-layer film produced in Example 23, the inorganic oxide alumina was vapor-deposited to a thickness of 30 nm by a known vacuum vapor deposition method to produce an inorganic-oxide-vapor-deposited biaxially stretched multi-layer film (AIOx/resin composition (A2)/polyethylene adhesive resin/polyethylene resin=30 nm/2 μm/2 μm/16 μm), which was evaluated in the same manner as in Example 19. The results are shown in Table 2.

### Comparative Example 7

An unstretched multi-layer film was produced in the same manner as in Example 23, except that a polypropylene resin (“Novatec™ PP EA7AD” manufactured by Japan Polypropylene Corporation, melting point: 157° C.) was used in place of the polyethylene resin, and that a polypropylene adhesive resin (“Admer™ QF500” manufactured by Mitsui Chemicals, Inc., melting point: 162° C.) was used in place of the polyethylene adhesive resin, and biaxially stretched; however, the film was broken during biaxial stretching.

### Comparative Example 8

A polyethylene resin film having a thickness of 20 μm was produced in the same manner as in Example 23, except that the resin composition (A2) pellets and the polyethylene adhesive resin were not used and the extrusion conditions were changed, and then biaxially stretched to produce a biaxially stretched polyethylene resin film, which was evaluated. The results are shown in Table 2.

### Comparative Example 9

On one surface of the biaxially stretched polyethylene resin film produced in Comparative Example 8, aluminum metal was vapor-deposited to a thickness of 50 nm by a known vacuum vapor deposition method to produce a metal-vapor-deposited biaxially stretched polyethylene resin film, which was evaluated in the same manner as in Example 19. The results are shown in Table 2.

TABLE 2

| | Multi-layer film | | | | | | | | | | | | | |
|---|---|---|---|---|---|---|---|---|---|---|---|---|---|---|
| | Resin | | Poly- | | | | | | | | Inorganic vapor- | | Evaluation | |
| | compo- | | ethylene | | | Thickness configuration | | | | | deposited layer (I) | | Gas barrier | |
| | sition | Adhesive | resin | Stretching ratio | | Layer | Layer | Layer | Total | Proportion | | Thick- | properties | |
| | (A) | resin (B) | (C) | MD | TD | (X) | (Y) | (Z) | thickness | of layer) | | ness | Before | After |
| | Type | Type | Type | direction | direction | (μm) | (μm) | (μm) | (μm) | (X) (%) | Type | (nm) | bending | bending |
| Example 19 | A2 | PE | PE | 1 | 1 | 2 | 2 | 16 | 20 | 10.0 | — | — | E | E |
| Example 20 | A2 | PE | PE | 1 | 1 | 10 | 5 | 5 | 20 | 50.0 | — | — | C | D |
| Example 21 | A2 | PE | PE | 4 | 1 | 2 | 2 | 16 | 20 | 10.0 | — | — | D | D |
| Example 22 | A2 | PE | PE | 1 | 4 | 2 | 2 | 16 | 20 | 10.0 | — | — | D | D |
| Example 23 | A2 | PE | PE | 4 | 4 | 2 | 2 | 16 | 20 | 10.0 | — | — | C | C |
| Example 24 | A2 | PE | PE | 4 | 4 | 2 | 2 | 16 | 20 | 10.0 | Al | 50 | A | B |
| Example 25 | A2 | PE | PE | 4 | 4 | 2 | 2 | 16 | 20 | 10.0 | AlOx | 30 | B | C |
| Comparative | A2 | PP | PP | 4 | 4 | 2 | 2 | 16 | 20 | 10.0 | — | — | Broken during | |
| Example 7 | | | | | | | | | | | | | stretching | |
| Comparative | — | — | PE | 4 | 4 | 0 | 0 | 20 | 20 | 0.0 | — | — | G | G |
| Example 8 | | | | | | | | | | | | | | |
| Comparative | — | — | PE | 4 | 4 | 0 | 0 | 20 | 20 | 0.0 | Al | 50 | E | G |
| Example 9 | | | | | | | | | | | | | | |

### Example 26

The multi-layer structure obtained in Example 1 (PE/adhesive/Al/resin composition/polyethylene adhesive resin/polyethylene resin=50 μm/2.5 μm/50 nm/5.5 μm/2.8 μm/25 μm) was crushed into pieces of 5 mm×5 mm or less in size. The crushed product and a polyethylene resin (“Novatec™ LD LJ400” manufactured by Japan Polyethylene Corporation; low-density polyethylene, melting point: 108° C.) were blended at a mass ratio (crushed product/polyethylene resin) of 40/60, and single-layer film formation was conducted with the resultant under extrusion conditions shown below to provide a recycled composition film having a thickness of 50 μm. The thickness of the film was adjusted by appropriately adjusting the screw rotation frequency and the take-up roll speed. As a control, a polyethylene film having a thickness of 50 μm was prepared in the same manner by using only a polyethylene resin.
Extruder: single-screw extruder manufactured by Toyo Seiki Seisaku-sho, Ltd.
Screw diameter: 20 mmq (L/D=20, compression ratio=3.5, full-flight screw)
Extrusion temperature: C1/C2/C3/D=160/190/190/190° C.
Take-up roll temperature: 50° C.

The recycled composition exhibited stable, good extrusion processability. Furthermore, the recycled composition film was almost comparable to the polyethylene film in terms of the amount of gel and hard spots, and, although slight coloring was found, the appearance was uniform and good.

1. A multi-layer film comprising at least a layer (X), a layer (Y), and a layer (Z) adjacently layered in this order, with the layer (X) being an outermost layer, wherein the layer (X) is made of a resin composition (A) comprising a modified ethylene-vinyl alcohol copolymer (a) obtained by modification with an epoxy compound and having a melting point of 110° C. or more and less than 150° C. as a main component, the layer (Y) comprises an adhesive resin (B) having a melting point of less than 150° C. as a main component, the layer (Z) comprises a polyethylene resin (C) having a melting point of less than 150° C. as a main component, and the resin composition (A) contains 20 to 1500 ppm of an alkali metal ion (b).

2. The multi-layer film according to claim 1, wherein the modified ethylene-vinyl alcohol copolymer (a) has an ethylene unit content of 20 to 60 mol %.

3. The multi-layer film according to claim 1, wherein the modified ethylene-vinyl alcohol copolymer (a) has a modifying group represented by the following general formula (I): 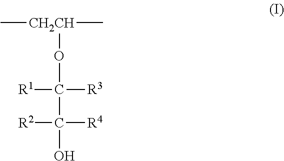
wherein R¹, R², R³, and R⁴ each independently represent a hydrogen atom, an aliphatic hydrocarbon group having 1 to 10 carbon atoms, an alicyclic hydrocarbon group having 3 to 10 carbon atoms, or an aromatic hydrocarbon group having 6 to 10 carbon atoms, R³ and R⁴ are optionally bonded to each other, and some or all of the hydrogen atoms of the aliphatic hydrocarbon group, the alicyclic hydrocarbon group, and the aromatic hydrocarbon group are each optionally replaced with a hydroxy group, a carboxyl group, or a halogen atom.

4. The multi-layer film according to claim 3, wherein in the modified ethylene-vinyl alcohol copolymer (a), a content of the modifying group represented by the general formula (I) is 1 mol % or more and less than 20 mol %.

5. The multi-layer film according to claim 1, wherein the adhesive resin (B) contains a carboxylic-acid-modified polyethylene resin as a main component.

6. The multi-layer film according to claim 1, wherein the layer (X) has a thickness of 0.2 μm or more and less than 20 μm, and a ratio of the thickness of the layer (X) to the total thickness of all layers of the multi-layer film is less than 25%.

7. The multi-layer film according to claim 1, wherein the multi-layer film is stretched at least monoaxially by 3 times or more and less than 12 times.

8. The multi-layer film according to claim 1, wherein the multi-layer film is stretched biaxially by 3 times or more and less than 12 times in each direction.

9. A vapor-deposited multi-layer film, comprising the multi-layer film according to claim 1 comprising an inorganic vapor-deposited layer (I) on an exposed surface side of the layer (X).

10. The multi-layer film or the vapor-deposited multi-layer film according to claim 1, wherein the multi-layer film performs an oxygen transmission rate (under conditions of 20° C., 65% RH) of less than 60 cc/(m²·day·atm) as measured in accordance with a method described in JIS K 7126-2 (equal-pressure method; 2006).

11. A multi-layer structure, being a laminate of the multi-layer film or the vapor-deposited multi-layer film according to claim 1, and at least one resin layer (R) comprising a thermoplastic resin (D) as a main component.

12. The multi-layer structure according to claim 11, wherein the thermoplastic resin (D) contains a polyethylene resin as a main component.

13. The multi-layer structure according to claim 11, wherein a ratio of the total thickness of a layer or layers containing a polyethylene resin as a main component to the total thickness of the multi-layer structure is 0.75 or more.

14. The multi-layer structure according to claim 11, comprising neither a layer containing a resin having a melting point of 240° C. or more as a main component nor a metal layer having a thickness of 1 μm or more.

15. A packaging material comprising the multi-layer structure according to claim 11.

16. A recycled composition comprising a recycled material from the multi-layer structure according to claim 11.

17. A method for recycling a multi-layer structure, the method comprising crushing the multi-layer structure according to claim 11 and then melt-molding the resultant.
